(19) United States
(12) Patent Application Publication
(10) Pub. No.: US 2025/0341538 A1
(43) Pub. Date: Nov. 6, 2025

(54) SYSTEM AND METHOD FOR CALCULATING AND EVALUATING ACCURACY OF SEA-SURFACE WIND SPEED USING IMPROVED INITIAL INPUT VALUES OF SEA-SURFACE WIND SPEED RADIOMETER

(71) Applicant: REPUBLIC OF KOREA (NATIONAL INSTITUTE OF METEOROLOGICAL SCIENCES), Seogwipo-si (KR)

(72) Inventors: Deok Du Kang, Seogwipo-si (KR); Min Seong Kim, Seogwipo-si (KR); Seung Beom Han, Seogwipo-si (KR); Sueng Pil Jung, Seogwipo-si (KR); Tae Young Goo, Seogwipo-si (KR); Myoung Hun Kang, Seogwipo-si (KR); Kwang Jae Lee, Seogwipo-si (KR); Jong Hun Shin, Seogwipo-si (KR); Chul Kyu Lee, Seogwipo-si (KR)

(73) Assignee: REPUBLIC OF KOREA (NATIONAL INSTITUTE OF METEOROLOGICAL SCIENCES), Seogwipo-si (KR)

(21) Appl. No.: 18/929,931

(22) Filed: Oct. 29, 2024

(30) Foreign Application Priority Data
May 3, 2024 (KR) 10-2024-0059110

(51) Int. Cl. G01P 21/00; G01P 5/00

(52) U.S. Cl. CPC G01P 21/00; G01P 5/00

(57) ABSTRACT

A system and method for calculating and evaluating accuracy of sea-surface wind speed using improved initial input values of a sea-surface wind speed radiometer are disclosed, which can calculate more improved sea-surface wind speed by enhancing the resolution of initial input values of the sea-surface wind speed radiometer, and evaluate the accuracy of the calculated sea-surface wind speed. The system for calculating and evaluating accuracy of sea-surface wind speed using improved initial input values of a sea-surface wind speed radiometer includes a grid data generation module, an improved sea-surface wind speed data generation module, and a sea-surface wind speed data verification module.

### CROSS-REFERENCE TO RELATED APPLICATIONS

This application claims the priority of Korean Patent Application No. 10-2024-0059110 filed on May 3, 2024, in the Korean Intellectual Property Office, the disclosure of which is incorporated herein by reference.

### BACKGROUND

### Field

The present invention relates to a system and method for calculating and evaluating accuracy of sea-surface wind speed, and more particularly, to a system and method for calculating and evaluating accuracy of sea-surface wind speed using improved initial input values of a sea-surface wind speed radiometer (SFMR) that can perform more improved sea-surface wind speed calculation and evaluate the accuracy of the calculated sea-surface wind speed.

### Description of the Related Art

For advance observation of hazardous weather phenomena such as heavy rain, typhoons, and heavy snow, aircraft observation data systems (AIMMS20), dropsondes, sea-surface wind speed radiometers (SFMR, Stepped Frequency Microwave Radiometer) or G-band vapor radiometers (GVR) are utilized.

Here, SFMR measures sea-surface wind speed for hazardous weather phenomena such as tropical typhoons, hurricanes, and precipitation systems through sea surface brightness temperatures observed in 6 frequency channels in the 4.5-7 GHz range. Sea-surface wind speed is calculated through initial input data such as brightness temperatures for each SFMR channel, sea surface temperature, salinity, etc.

In particular, since SFMR observes sea-surface wind speed based on the degree of foam generated by wind on the sea surface, it has high observation accuracy for strong sea winds of 15 m/s or higher. SFMR is generally used to analyze the meteorological structure of typhoons and hurricanes. SFMR measures sea-surface wind speed installed on meteorological aircraft flying in extreme sea wind environments of 20 m/s or higher.

The Korea Meteorological Administration's meteorological aircraft performs over 100 observations per year using SFMR, of which over 40% are advance observations of hazardous weather phenomena. Most of the advance observation missions for hazardous weather phenomena are performed under sea wind speed conditions of 15 m/s or less considering aircraft operational capabilities, so technology to improve observation accuracy is needed to increase SFMR utilization in the sea wind speed range of 15 m/s or less.

### RELATED ART DOCUMENT

[Patent Document]

(Patent Document 1) Korean Patent Application Publication No. 10-2022-0126508 (Published on Sep. 16, 2022)

### SUMMARY

An object of the present invention is to provide a system and method for calculating and evaluating accuracy of sea-surface wind speed using improved initial input values of a sea-surface wind speed radiometer that can perform more improved sea-surface wind speed calculation and evaluate the accuracy of the calculated sea-surface wind speed.

In order to achieve the aforementioned object, according to one embodiment of the present invention, a system for calculating and evaluating accuracy of sea-surface wind speed using improved initial input values of a sea-surface wind speed radiometer that calculates sea-surface wind speed based on sea surface brightness temperature value information measured at sea, aircraft position and attitude information, sea surface temperature (SST) information and salinity concentration information, wherein the system comprises: a grid data generation module that generates multiple grid information containing information about sea surface temperature and salinity concentration within a certain area based on previously measured sea surface temperature information and previously measured salinity concentration information; an improved sea-surface wind speed data generation module that calculates improved sea-surface wind speed by applying the sea surface temperature information and salinity concentration information in the generated multiple grid information to the sea-surface wind speed radiometer; and a sea-surface wind speed data verification module that evaluates accuracy of the calculated sea-surface wind speed by comparing the calculated sea-surface wind speed with heterogeneous data.

The grid data generation module generates the multiple grid information based on the previously measured sea surface temperature information and previously measured salinity concentration information from marine observation data of the Meteorological Administration, buoys of the Hydrographic and Oceanographic Agency, marine science stations and tide observation stations.

The grid data generation module generates the multiple grid information having a spatial resolution of 0.1°×0.1° within the certain area.

The grid data generation module generates multiple grid information having a time resolution corresponding to the generation interval of buoy data within the certain area.

The multiple grid information has a time resolution of 30-minute intervals within the certain area.

The grid data generation module verifies accuracy of the multiple grid information after generating the multiple grid information, and when verifying accuracy of the multiple grid information, compares sea surface temperature information included in each grid of the multiple grid information with sea surface temperature information in the 5th generation reanalysis data (ERA5) provided by the European Centre for Medium-Range Weather Forecasts (ECMWF).

The sea-surface wind speed data verification module calculates a moving average of the calculated sea-surface wind speed within a predetermined time to correct the calculated sea-surface wind speed information and remove noise.

The sea-surface wind speed data verification module evaluates accuracy of the improved sea-surface wind speed calculation by comparing the calculated sea-surface wind speed with sea-surface wind speed information observed by marine buoys.

The sea-surface wind speed data verification module evaluates accuracy of the improved sea-surface wind speed calculation by comparing the calculated sea-surface wind speed with sea-surface wind speed information observed by dropsondes.

The sea-surface wind speed information observed by the dropsonde applies the sea-surface wind speed value measured when the dropsonde reached the sea surface.

In order to achieve the aforementioned object, according to one embodiment of the present invention, a method for calculating and evaluating accuracy of sea-surface wind speed using improved initial input values of a sea-surface wind speed radiometer that calculates sea-surface wind speed based on sea surface brightness temperature value information measured at sea, aircraft position and attitude information, sea surface temperature (SST) information and salinity concentration information, wherein the method comprises: a grid data generation step in which a grid data generation module generates multiple grid information containing information about sea surface temperature and salinity concentration within a certain area based on previously measured sea surface temperature information and previously measured salinity concentration information; an improved sea-surface wind speed data generation step in which an improved sea-surface wind speed data generation module calculates improved sea-surface wind speed by applying the sea surface temperature information and salinity concentration information in the generated multiple grid information to the sea-surface wind speed radiometer; and a sea-surface wind speed data verification step in which a sea-surface wind speed data verification module evaluates accuracy of the calculated sea-surface wind speed by comparing the calculated sea-surface wind speed with heterogeneous data.

In the grid data generation step, the previously measured sea surface temperature information and previously measured salinity concentration information are from marine observation data of the Meteorological Administration, buoys of the Hydrographic and Oceanographic Agency, marine science stations and tide observation stations.

The multiple grid information generated in the grid data generation step has a spatial resolution of 0.1°×0.1° within the certain area.

The multiple grid information generated in the grid data generation step has a time resolution corresponding to the generation interval of buoy data within the certain area.

The multiple grid information generated in the grid data generation step has a time resolution of 30-minute intervals.

The grid data generation step includes a grid data verification step of verifying accuracy of the multiple grid information after generating the multiple grid information, and the grid data verification step compares sea surface temperature information included in each grid of the multiple grid information with sea surface temperature information in the 5th generation reanalysis data (ERA5) provided by the European Centre for Medium-Range Weather Forecasts (ECMWF).

The sea-surface wind speed data verification step includes a moving average calculation step of calculating a moving average of the calculated sea-surface wind speed within a predetermined time to correct the calculated sea-surface wind speed information and remove noise.

The sea-surface wind speed data verification step includes a buoy sea-surface wind speed data comparison step of evaluating accuracy of the improved sea-surface wind speed calculation by comparing the calculated sea-surface wind speed with sea-surface wind speed information observed by marine buoys.

The sea-surface wind speed data verification step includes a dropsonde sea-surface wind speed data comparison step of evaluating accuracy of the improved sea-surface wind speed calculation by comparing the calculated sea-surface wind speed with sea-surface wind speed information observed by dropsondes.

The sea-surface wind speed information observed by the dropsonde applies the sea-surface wind speed value observed when the dropsonde reached the sea surface.

According to the system and method for calculating and evaluating accuracy of sea-surface wind speed using improved initial input values of a sea-surface wind speed radiometer of the present invention, more improved sea-surface wind speed can be calculated, and the accuracy of the calculated sea-surface wind speed can be evaluated.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram briefly showing each configuration of a system 1000 for calculating and evaluating accuracy of sea-surface wind speed using improved initial input values of a sea-surface wind speed radiometer according to the present invention.

FIG. 2 shows the flight paths of the SW-01 observation missions in 2022, dropsonde drop points, and locations of buoys and ocean science stations used for SFMR sea-surface wind speed comparison analysis.

FIG. 3A is a diagram showing sea surface temperature grid data generated by the grid data generation module 100.

FIG. 3B is a diagram showing salinity concentration grid data generated by the grid data generation module 100.

FIG. 4A shows scatter plots of SST grid data generated based on data acquired at point 1 (SCC; SoCheongcho Ocean Research Station) and ERA5 SST data.

FIG. 4B shows scatter plots of SST grid data generated based on data acquired at point 2 (Yellow Sea; West Sea) and ERA5 SST data.

FIG. 5A is a diagram showing correlation analysis results between sea-surface wind speed calculation results of the conventional SFMR device and sea-surface wind speed observed by buoys.

FIG. 5B is a diagram showing correlation analysis results between sea-surface wind speed calculation results with 1-minute moving average of SFMR data applied and sea-surface wind speed observed by buoys.

FIG. 5C is a diagram showing correlation analysis results between sea-surface wind speed calculation results with both 1-minute moving average of SFMR data and new calibration coefficients applied, and sea-surface wind speed observed by buoys.

FIG. 6A is a diagram showing correlation analysis results between sea-surface wind speed calculation results of the conventional SFMR device and sea-surface wind speed observed by dropsondes.

FIG. 6B is a diagram showing correlation analysis results between sea-surface wind speed calculation results with new calibration coefficients applied and sea-surface wind speed observed by dropsondes.

FIGS. 7 and 8 are flowcharts showing each step of a method for calculating sea-surface wind speed and evaluating accuracy through an improved initial input value of the sea-surface wind speed radiometer according to the present invention.

FIG. 9 is a block diagram showing each component of the sea-surface wind speed calculation and accuracy evaluation system 1000 through an improved initial input value of the sea-surface wind speed radiometer according to an embodiment of the present invention.

FIG. 10 is a flowchart showing each step of the method for calculating sea-surface wind speed and evaluating accuracy through an improved initial input value of the sea-surface wind speed radiometer according to an embodiment of the present invention.

FIG. 11A is a diagram showing SFMR sea surface brightness temperature before applying new calibration coefficients, and FIG. 11B is a diagram showing SFMR sea surface brightness temperature when new calibration coefficients are applied based on observation data collected from the calibration flight on Oct. 26, 2022.

### DETAILED DESCRIPTION OF THE EMBODIMENT

Hereinafter, some embodiments of the present invention will be described in detail through exemplary drawings. It should be noted that in adding reference numerals to components in each drawing, the same components have the same reference numerals as possible even if shown in different drawings.

And in explaining embodiments of the present invention, if it is determined that detailed description of related known configurations or functions hinders the understanding of embodiments of the present invention, such detailed description will be omitted.

Also, in describing components of embodiments of the present invention, terms such as first, second, A, B, (a), (b), etc. may be used. These terms are only to distinguish the component from other components, and the nature, order or sequence, etc. of the corresponding component is not limited by that term.

In this specification, the singular form includes the plural form unless specifically mentioned otherwise in the context. The terms “include” and/or “including” used in the specification do not exclude the presence or addition of one or more other components besides the mentioned components.

A known sea-surface wind speed radiometer (SFMR, Stepped Frequency Microwave Radiometer) 10 calculates sea-surface wind speed based on sea surface brightness temperature value information measured at sea, aircraft position and attitude information (Altitude, Pitch, Roll), sea surface temperature (SST) information, and salinity concentration information.

Sea surface brightness temperature value information and aircraft position and attitude information are collected and provided in real-time through observation equipment installed on the aircraft.

However, for marine observation data such as SST and salinity concentration, there is a problem that the spatial and temporal resolution of the marine observation data is relatively less dense compared to sea surface brightness temperature value information and aircraft position and attitude information, as a single data collected from a specific marine science station near the mission area the day before the observation mission is input.

The system 1000 and method for calculating and evaluating accuracy of sea-surface wind speed using improved initial input values of a sea-surface wind speed radiometer according to the present invention generate ocean grid data having a high spatial resolution of 0.1°×0.1° and a time resolution of 30 minutes by utilizing SST and salinity concentration of marine observation data from the Meteorological Administration, buoys of the Hydrographic and Oceanographic Agency, marine science stations, and tide observation stations, and calculate more improved sea-surface wind speed based on improved high-resolution initial input data by applying SST information and salinity concentration information in the generated ocean grid data to the initial input values of the sea-surface wind speed radiometer.

Hereinafter, the present invention will be described in more detail with reference to the accompanying drawings.

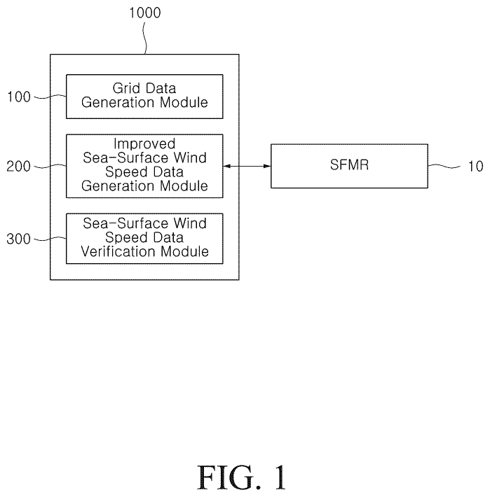

FIG. 1 is a block diagram briefly showing each configuration of a system 1000 for calculating and evaluating accuracy of sea-surface wind speed using improved initial input values of a sea-surface wind speed radiometer according to the present invention.

Referring to FIG. 1, the system 1000 for calculating and evaluating accuracy of sea-surface wind speed using improved initial input values of a sea-surface wind speed radiometer according to the present invention includes a grid data generation module 100, an improved sea-surface wind speed data generation module 200, and a sea-surface wind speed data verification module 300.

The grid data generation module 100 according to an embodiment of the present invention generates multiple grid information containing information about the sea-surface temperature and the salinity concentration within a predetermined certain area based on previously measured sea surface temperature information and previously measured salinity concentration information.

The improved sea-surface wind speed data generation module 200 according to the present invention calculates improved sea-surface wind speed by applying sea surface temperature information and salinity concentration information in the multiple grid information generated by the grid data generation module 100 to the initial input data of the sea-surface wind speed radiometer (SFMR) 10.

The sea-surface wind speed data verification module 300 according to the present invention evaluates and verifies the accuracy of the calculated sea-surface wind speed by comparing the improved sea-surface wind speed information calculated by the improved sea-surface wind speed data generation module 200 with heterogeneous data.

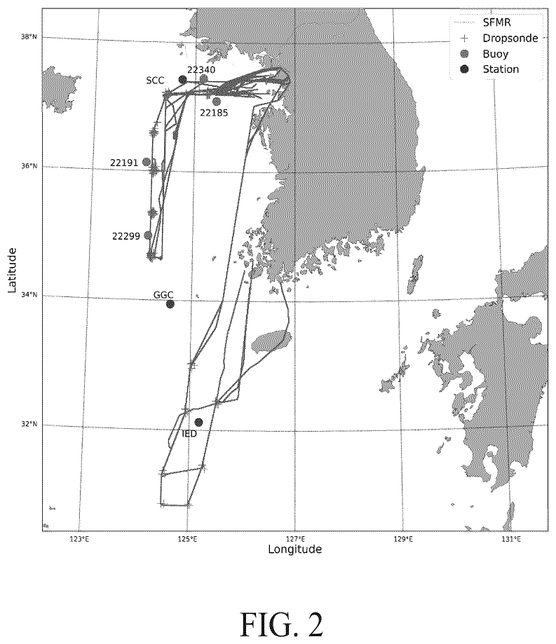

FIG. 2 is a diagram showing flight paths of observation missions, dropsonde drop points, and locations of buoys and ocean science stations used by the grid data generation module 100 according to an embodiment of the present invention to generate multiple grid information.

The grid data generation module 100 generates multiple grid information based on previously measured sea surface temperature information and previously measured salinity concentration information from marine observation data of the Meteorological Administration, dropsondes, buoys of the Hydrographic and Oceanographic Agency, marine science stations and/or tide observation stations.

FIG. 2 shows the flight paths of the SW-01 observation missions in 2022, dropsonde drop points, and locations of buoys and ocean science stations used for SFMR sea-surface wind speed comparison analysis.

As one embodiment, the grid data generation module 100 generates multiple grid information based on sea surface temperature information and salinity concentration information collected from observation missions performed within a certain period as shown in FIG. 2.

As one embodiment, the grid data generation module 100 can generate multiple grid information based on sea-surface temperature information and salinity concentration information collected by the Meteorological Administration, dropsondes, buoys of the Hydrographic and Oceanographic Agency, marine science stations and/or tide observation stations from 25 SW-01 missions (hazardous weather advance observation missions, missions to analyze vertical distribution change characteristics of atmospheric meteorological factors over the sea for heavy rain occurrence) performed from Jun. 22 to Sep. 22, 2022, as shown in FIG. 2. In the 25 SW-01 missions performed from Jun. 22 to Sep. 22, 2022, there are about 200 observation points for SST and about 13 observation points for salinity concentration. At this time, the grid data generation module 400 can set the time resolution of all data to 30-minute intervals as buoy data is generated at 30-minute intervals.

As one embodiment, the grid data generation module 100 can set SST and salinity concentration grid data areas considering the observation paths of the meteorological aircraft in the West Sea, South Sea, and East China Sea. For the northern part of the East Sea, it can be set for future comparison with SFMR data collected in the East Sea.

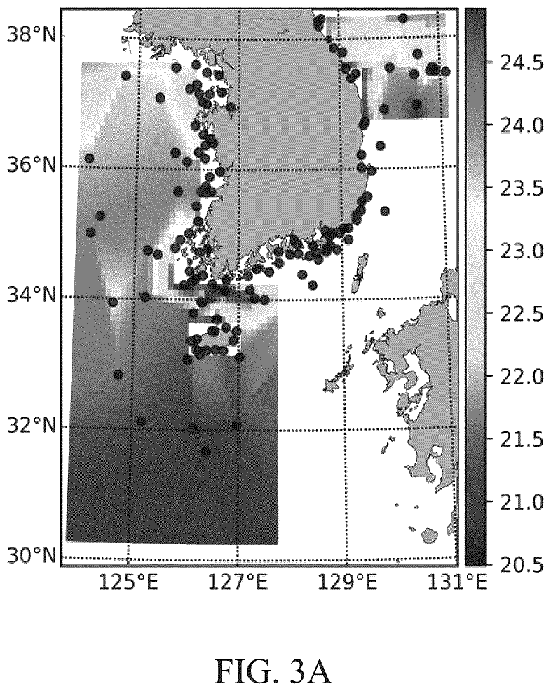

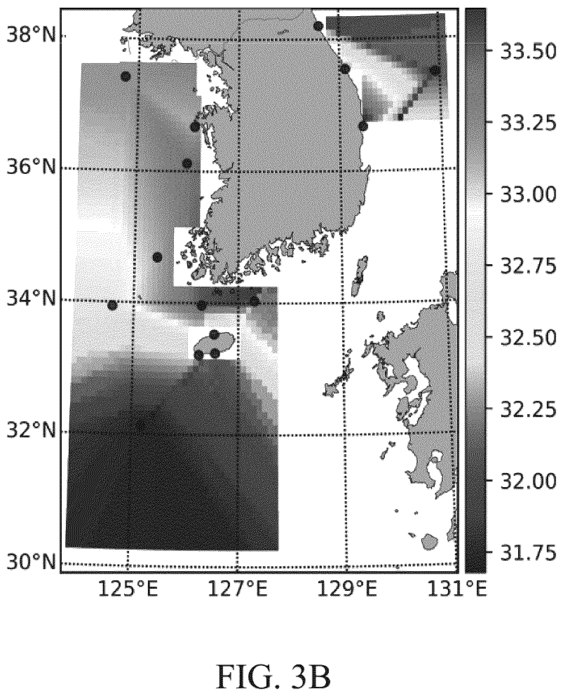

FIG. 3A is a diagram showing sea surface temperature grid data generated by the grid data generation module 100. FIG. 3B is a diagram showing salinity concentration grid data generated by the grid data generation module 100.

From the West Sea to the East China Sea, it has a spatial resolution of 39°×74°, and the East Sea has a spatial resolution of 29°×16°.

Referring to FIG. 3A and FIG. 3B, the grid data generation module 100 can generate multiple grid information with a spatial resolution of 0.1°×0.1° in certain areas from the West Sea to the East China Sea, and over the East Sea. That is, the grid data generation module 100 can grid the 39°×74° area from the West Sea to the East China Sea to have a spatial resolution of 0.1°×0.1°, and grid the 29°×16° area over the East Sea to have a spatial resolution of 0.1°×0.1°.

The grid data generation module 100 generates multiple grid information with a time resolution corresponding to the generation interval of buoy data in certain areas from the West Sea to the East China Sea and over the East Sea.

As mentioned earlier, the grid data generation module 100 can set the time resolution of all data to 30-minute intervals as buoy data is generated at 30-minute intervals. That is, the multiple grid information generated by the grid data generation module 100 includes sea surface temperature information and salinity concentration information with a 30-minute time interval.

The grid data generation module 100 can generate multiple grid information using the known linear interpolation method that obtains values through linear approximation between observation points and the known extrapolation method through the K-Nearest Neighbor Regression (K-NN Regression) algorithm. The grid data generation module 100 can grid certain areas as shown in FIGS. 3A and 3B by applying distance-based weights to both interpolation and extrapolation methods.

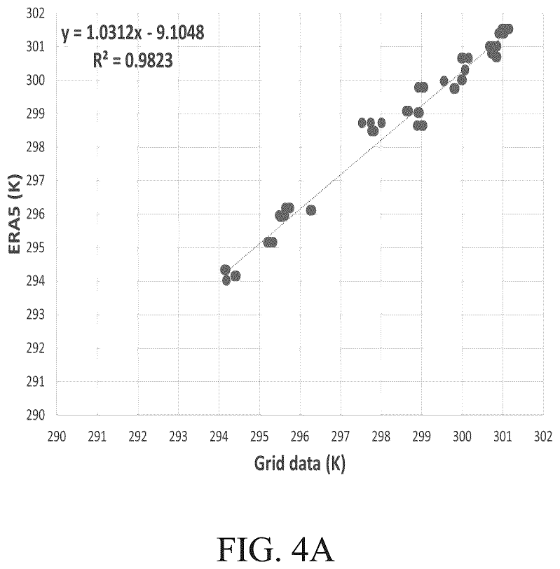

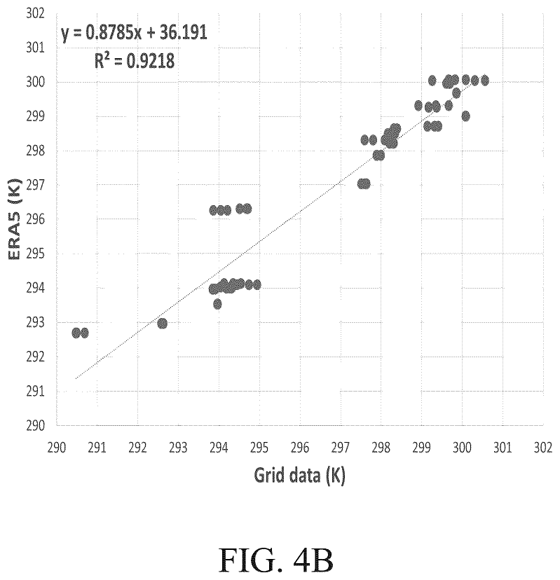

FIG. 4A shows scatter plots of SST grid data generated based on data acquired at point 1 (SCC; SoCheongcho Ocean Research Station) and ERA5 SST data, and FIG. 4B shows scatter plots of SST grid data generated based on data acquired at point 2 (Yellow Sea; West Sea) and ERA5 SST data.

The grid data generation module 100 verifies the accuracy of the generated multiple grid information after generating multiple grid information based on sea surface temperature information and salinity concentration information collected from observation missions performed within a certain period.

When verifying the accuracy of the generated multiple grid information, the grid data generation module 100 can verify the accuracy of the generated multiple grid information by comparing sea surface temperature information included in each of the multiple grids with sea surface temperature information in the 5th generation reanalysis data (ERA5) provided by the European Centre for Medium-Range Weather Forecasts (ECMWF).

The grid data generation module 100 can verify the accuracy of the generated multiple grid information by comparing sea surface temperature information at a specific point in the generated multiple grid information with sea surface temperature information at that specific point in the 5th generation reanalysis data (ERA5).

As one embodiment, the grid data generation module 100 can select a total of 4 points as specific points: 2 points in the West Sea (P1, P2), 1 point in the southern part of Jeju (P3), and 1 point in the southern part of leodo (P4). The specific points can be selected from the SFMR 10 observation path. The grid data generation module 100 compares sea surface temperature information at each of these specific points.

Referring to FIG. 4A, 4B and Table 1, the correlation value (CC) at all points showed an average of 0.97, and the Root Mean Squared Error (RMSE) showed an average of 0.99K. Therefore, it can be confirmed that the multiple grid information generated by the grid data generation module 100 has sufficient reliability to be used as initial input data for SFMR 10.

TABLE 1

| Point | CC | RMSE (K) |
|---|---|---|
| P1 | 0.96 | 0.78 |
| P2 | 0.99 | 0.39 |
| P3 | 0.98 | 1.18 |
| P4 | 0.98 | 0.81 |

The improved sea-surface wind speed data generation module 200 according to the present invention can calculate improved sea-surface wind speed based on the multiple grid information generated by the grid data generation module 100. The improved sea-surface wind speed data generation module 200 calculates improved sea-surface wind speed by applying sea surface temperature information and salinity concentration information in the multiple grid information generated by the grid data generation module 400 as initial values for SFMR 10. That is, the improved sea-surface wind speed data generation module 200 calculates improved sea-surface wind speed by changing the initial values of sea surface temperature and salinity concentration of SFMR 10 to sea surface temperature values and salinity concentration values in the multiple grid information generated by the grid data generation module 100.

When applying sea surface temperature information and salinity concentration information in the multiple grid information as initial values for SFMR 10, the improved sea-surface wind speed data generation module 200 calculates improved sea-surface wind speed by applying sea surface temperature values and salinity concentration values in the grid information closest in time and space during the sea-surface wind speed observation mission as those initial values.

The average aircraft observation time of SW-01 performed in the West Sea, South Sea, and East China Sea is about 2-4 hours. The improved sea-surface wind speed data generation module 200 can calculate more improved sea-surface wind speed by selecting 4-8 SST and salinity concentration grid data at 30-minute intervals considering the takeoff and landing times of the aircraft for each observation mission, and applying SST and salinity concentration values of the grid point closest to the position (latitude and longitude) of the meteorological aircraft during the observation mission instead of the existing initial input values.

The sea-surface wind speed data verification module 300 according to the present invention evaluates the accuracy of the sea-surface wind speed calculated by the improved sea-surface wind speed data generation module 200 by comparing it with heterogeneous data.

The sea-surface wind speed data verification module 300 uses the observation data of marine buoys and dropsondes, which are heterogeneous data where sea-surface wind speed is observed, to verify the observation accuracy of the SFMR sea-surface wind speed reproduced through the application of initial input data with high temporal and spatial resolution.

The sea-surface wind speed data verification module 300 calculates a moving average of the calculated sea-surface wind speed within a predetermined time, and evaluates the accuracy of the calculated sea-surface wind speed by comparing that moving average value with heterogeneous data.

Since SFMR 10 measures sea surface brightness temperature through radiation energy emitted from the ocean, observation starts 5-10 minutes before the aircraft moves from land to sea, considering equipment warm-up time for each observation mission. Although SFMR 10 considers the boundary between land and sea during observation and sea-surface wind speed calculation, in oceans close to the coastline, energy emitted from the land surface may contaminate radiation energy data due to the side-lobe effect of the SFMR 10 antenna.

The sea-surface wind speed data verification module 300 performs comparative analysis by calculating a 1-minute moving average of SFMR sea-surface wind speed to correct such observation data and remove noise that may occur due to second-by-second remote sensing at 0.9 Hz.

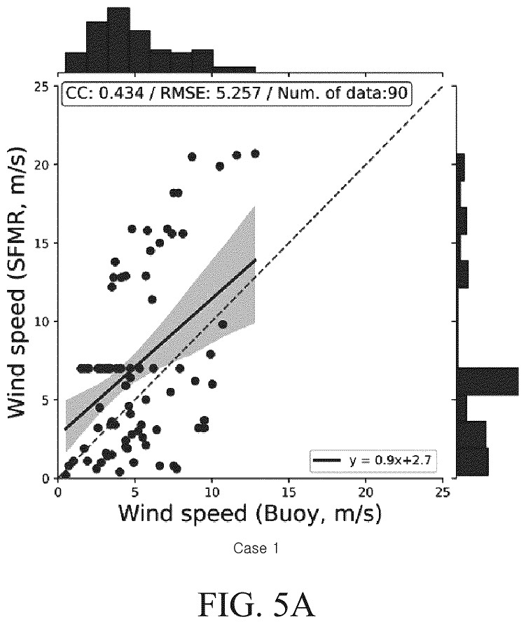

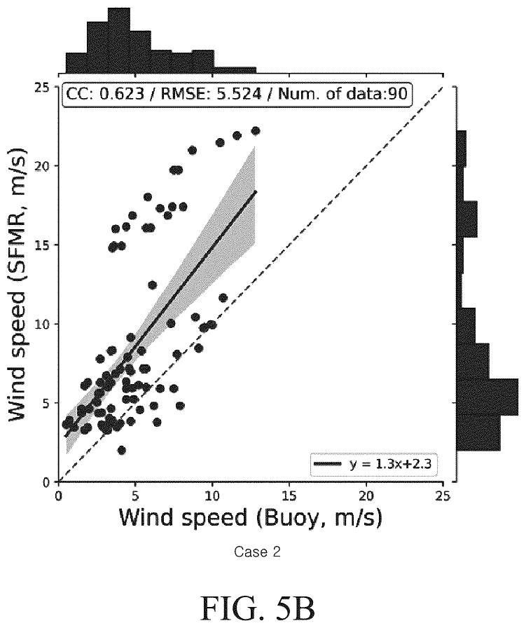

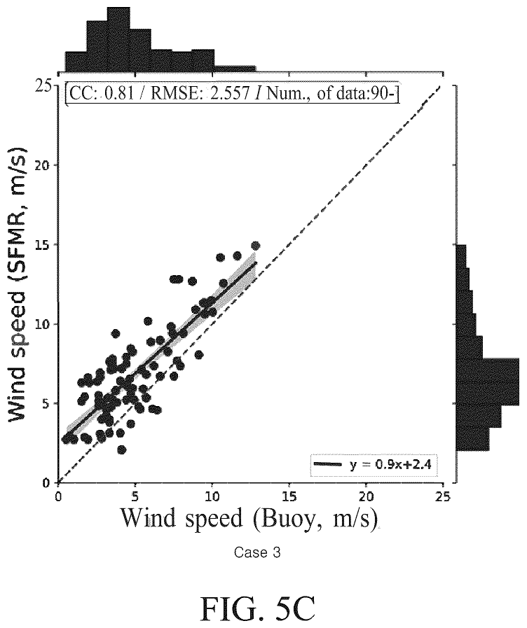

FIG. 5A is a diagram showing correlation analysis results between sea-surface wind speed calculation results of the conventional SFMR device and sea-surface wind speed observed by buoys. FIG. 5B is a diagram showing correlation analysis results between sea-surface wind speed calculation results with 1-minute moving average of SFMR data applied and sea-surface wind speed observed by buoys. FIG. 5C is a diagram showing correlation analysis results between sea-surface wind speed calculation results with both 1-minute moving average of SFMR data and new calibration coefficients applied, and sea-surface wind speed observed by buoys.

The sea-surface wind speed data verification module 300 according to the present invention, compares the sea-surface wind speed calculated by the improved sea-surface wind speed data generation module 200 based on the grid information generated by the grid data generation module 100, with the sea-surface wind speed information observed by the marine buoy, and evaluates the accuracy of the sea-surface wind speed calculation of the improved sea-surface wind speed data generation module 200.

The sea-surface wind speed data verification module 300 selects marine buoys to be compared with the sea-surface wind speed calculated by the improved sea-surface wind speed data generation module 200. As one embodiment, the sea-surface wind speed data verification module 300 can select 4 marine buoys located in the West Sea, which is the main observation area of 25 SW-01 missions (hazardous weather advance observation missions, missions to analyze vertical distribution change characteristics of atmospheric meteorological factors over the sea for heavy rain occurrence) performed from Jun. 22 to Sep. 22, 2022 (Korea Hydrographic and Oceanographic Agency: Northwestern Gyeonggi Bay/Korea Meteorological Administration: Incheon, West Sea 170, West Sea 190). The 4 marine buoys selected by the sea-surface wind speed data verification module 300 may be marine buoys located less than 50 km away from the SFMR 10 observation path. The observation resolution (time resolution) of the buoy is 30 minutes, and the observation resolution (time resolution) of SFMR 10 is 1 second, resulting in a difference in time resolution. The sea-surface wind speed data verification module 300 can set the time resolution of SFMR 10 to 30 minutes each to correspond to the time resolution of the buoy. As one embodiment, the sea-surface wind speed data verification module 300 can select a total of 90 data each for comparison between the buoy and SFMR 10.

The sea-surface wind speed data verification module 300 can produce correlation analysis results of SFMR sea-surface wind speed and buoy-observed sea-surface wind speed in a total of 3 stages including Cases 1-3, as shown in FIG. 5A, 5B, 5C and Table 2, to evaluate the accuracy of the sea-surface wind speed calculation of the improved sea-surface wind speed data generation module 200 based on sea-surface wind speed information observed by buoys.

TABLE 2

| | 1-min. | Reprocessing | | |
|---|---|---|---|---|
| | moving ave. | initial values | CC | RMSE |
| Case 1 | x | x | 0.43 | 5.25 |
| Case 2 | ∘ | x | 0.62 | 5.52 |
| Case 3 | ∘ | ∘ | 0.81 | 2.55 |

Referring to FIG. 5A, Case 1 is about the correlation analysis result between the sea-surface wind speed calculated by the conventional SFMR device (10) and the sea-surface wind speed observed by the buoy. Case 1 is about the correlation analysis result between the sea-surface wind speed calculated by the SFMR device (10) to which the aforementioned improved sea-surface wind speed calculation processes are not applied and the sea-surface wind speed observed by the buoy.

Referring to FIG. 5B, Case 2 is about the correlation analysis results between the sea-surface wind speed calculation results with the 1-minute moving average of SFMR data calculated by the sea-surface wind speed data verification module 300 applied and the sea-surface wind speed observed by buoys.

Referring to FIG. 5C, Case 3 is about the correlation analysis result between the improved sea-surface wind speed calculated by the improved sea-surface wind speed data generation module 200 based on the plurality of grid information generated by the grid data generation module 100 and the sea-surface wind speed observed by the buoy, along with the application of the 1-minute moving average of the SFMR 10 data calculated by the sea-surface wind speed data verification module 300.

In Case 1, a relatively low correlation (CC) of 0.43 was shown, and the root mean square error (RMSE) showed a considerably large deviation of 5.25 m/s. In the SFMR data of Case 1, a value of 7 m/s was frequently produced in the process of calculating wind speed. These values were produced in the sea-surface wind speed calculation process of the equipment itself, and the validity of the values was determined through the Data valid value (0: verified data, 1: unverified data).

In Case 2, the correlation (CC) between observation equipment gradually increased, but there was no significant change in the root mean square error (RMSE), which was over 5 m/s. In Case 2, the 7 m/s value produced in Case 1 was calculated to be relatively close to the observed value through the 1-minute moving average calculation, and weak wind speeds below 3 m/s were generally adjusted upward. However, the aspect of being divided into two groups based on 10 m/s also appeared in Case 2.

In Case 3, a correlation (CC) of 0.81 and a root mean square error (RMSE) of 2.55 m/s were shown, and it was confirmed that the correlation and the error between the data were significantly improved compared to the results of Case 1. In Case 3, it can be confirmed that the SFMR wind speed, which was divided into two parts in Case 2, is close to the reference line with a slope of 1, and in particular, the data in the strong wind speed range of 15 m/s or more to 25 m/s or more is adjusted downward. Among the entire process, the application of high-resolution initial input data had the most significant effect.

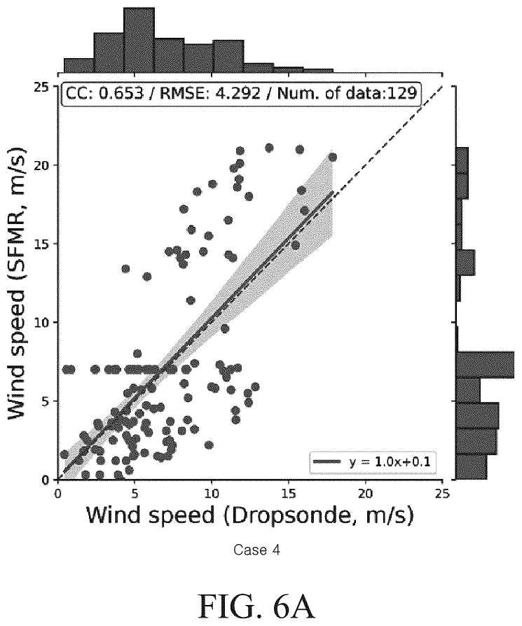

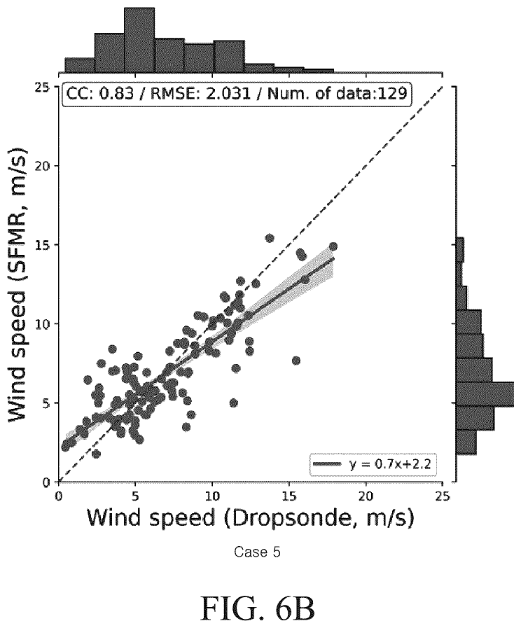

FIG. 6A is a diagram showing correlation analysis results between sea-surface wind speed calculation results of the conventional SFMR device and sea-surface wind speed observed by dropsondes. FIG. 6B is a diagram showing correlation analysis results between sea-surface wind speed calculation results with new calibration coefficients applied and sea-surface wind speed observed by dropsondes.

The sea-surface wind speed data verification module 300 compares the sea-surface wind speed calculated by the improved sea-surface wind speed data generation module 200 based on the grid information generated by the grid data generation module 100 with the sea-surface wind speed information observed by the dropsonde to evaluate the accuracy of the sea-surface wind speed calculation of the improved sea-surface wind speed data generation module 200.

When comparing the sea-surface wind speed calculated by the improved sea-surface wind speed data generation module 200 based on the grid information generated by the grid data generation module 100 with the sea-surface wind speed information observed by the dropsonde, the sea-surface wind speed data verification module 300 can evaluate the accuracy of the sea-surface wind speed calculation of the improved sea-surface wind speed data generation module 200 by applying the sea-surface wind speed value measured when the dropsonde reaches the sea surface.

As the dropsonde sensor gets closer to the sea surface, the instability of observation data increases due to various factors such as satellite signal reduction, and data below a certain altitude may not be observed or outliers may be observed. Therefore, the sea-surface wind speed data verification module 300 according to the present invention calculates statistics (mean, median, maximum) of sea wind speed values observed by dropsondes at altitudes of 500 m, 150 m, and 30 m from the sea surface, respectively, and can compare the calculation results with SFMR data.

The comparison results between sea-surface wind speed values observed by dropsondes at 150 m altitude from the sea surface and SFMR data are shown in FIG. 6A, 6B and Table 3. Also, z-scores were calculated for dropsonde wind speeds below 1000 m, and wind speed outliers exceeding 95% confidence (1.96) among data below 100 m close to the sea surface were removed.

TABLE 3

| | Reprocessing | | |
|---|---|---|---|
| | initial values | CC | RMSE |
| Case 4 | x | 0.65 | 4.29 |
| Case 5 | ∘ | 0.83 | 2.03 |

During the approximately 10 minutes it takes for a dropsonde dropped from an aircraft to reach the sea surface, the aircraft moves an average distance of about 50 km. Since SFMR 10 calculates sea-surface wind speed in 0.9 Hz units, the sea-surface wind speed data verification module 300 selected and analyzed observation data where the time at which the two devices, SFMR 10 and dropsonde, observed the wind speed of the sea surface matched.

To evaluate the quality of the improved SFMR sea-surface wind speed calculation, the change in data quality by SFMR 10 stages for the application of high-resolution initial input data was also analyzed together. The impact analysis of the 1-minute moving average of SFMR data was explained to have relatively weak wind speed quality improvement through comparison analysis with buoys, so its description is omitted.

Referring to FIG. 6A, Case 4 is about the correlation analysis results between the sea-surface wind speed calculation results of the conventional SFMR device 10 and the sea-surface wind speed observed by dropsondes. In Case 4, a correlation (CC) of 0.65 and a root mean square error (RMSE) of 4.29 m/s were shown. Compared to the results with buoys, it showed relatively high correlation, but showed a picture of being divided into a weak wind speed group below 10 m/s and a strong wind speed group above that.

Referring to FIG. 6B, Case 5 is about the correlation analysis result between the improved sea-surface wind speed calculated by the improved sea-surface wind speed data generation module 200 based on the plurality of grid information generated by the grid data generation module 100 and the sea-surface wind speed observed by the dropsonde. In Case 5, where the initial input value was improved, the observed value calculated as 7 m/s was recalculated as in the analysis result with the buoy, and a correlation (CC) of 0.83 and a root mean square error (RMSE) of 2.03 m/s were shown. Compared to the results of Case 4, it was confirmed that the correlation and the error between the data were significantly improved through the improvement of the initial input values of the sea surface temperature information and salinity concentration information by generating a plurality of grid information.

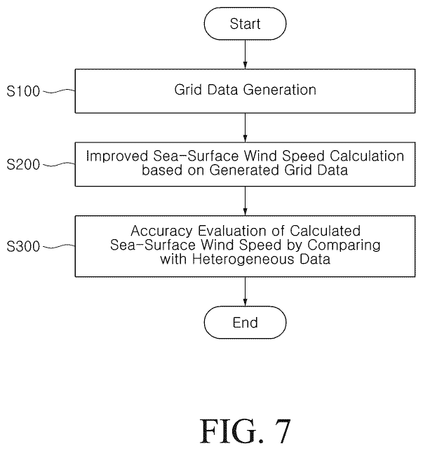

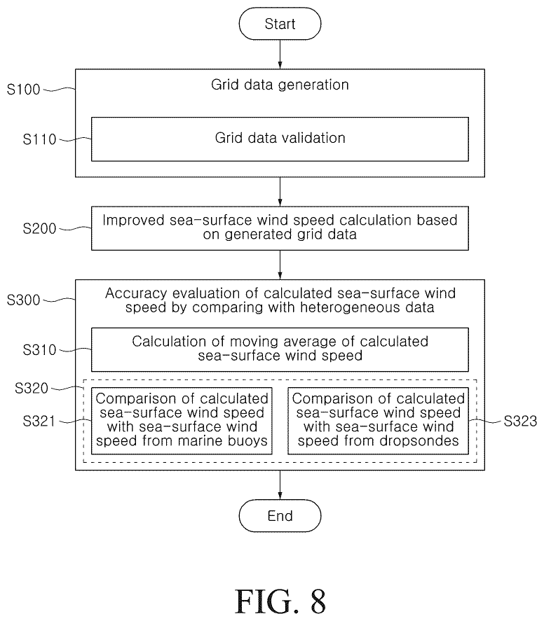

FIGS. 7 and 8 are flowcharts showing each step of a method for calculating sea-surface wind speed and evaluating accuracy through an improved initial input value of the sea-surface wind speed radiometer according to the present invention.

The method for calculating sea-surface wind speed and evaluating accuracy through an improved initial input value of the sea-surface wind speed radiometer according to the present invention includes a grid data generation step (S100) by the grid data generation module 100, an improved sea-surface wind speed data generation step (S200) by the improved sea-surface wind speed data generation module 200, and a sea-surface wind speed data verification step (S300) by the sea-surface wind speed data verification module, as shown in FIGS. 7 and 8.

In step (S100), the grid data generation module 100 generates a plurality of grid information having information on sea-surface temperature and salinity concentration in a predetermined certain area based on the measured sea surface temperature information and the measured salinity concentration information.

In step (S100), the measured sea-surface temperature information and the measured salinity concentration information that serve as the basis for generating the plurality of grid information utilize the measured SST information and salinity concentration information in Meteorological Administration, dropsondes, buoys of the Hydrographic and Oceanographic Agency, marine science stations, and tide observation stations marine observation data.

In step (S100), the grid data generation module 100 generates a plurality of grid information having a spatial resolution of 0.1°×0.1° in each predetermined certain area and a time resolution of 30 minutes corresponding to the generation interval of buoy data.

Step (S100) includes a grid data verification step (S110) for verifying the accuracy of the generated plurality of grid information.

In step (S110), the accuracy of the generated plurality of grid information can be verified by comparing the sea surface temperature information included in each grid of the plurality of grid information with the sea surface temperature information in the 5th generation reanalysis data (ERA5) provided by the European Centre for Medium-Range Weather Forecasts (ECMWF).

In step (S200), the improved sea-surface wind speed data generation module 200 calculates improved sea-surface wind speed based on the plurality of grid information generated by the grid data generation module 100.

In step (S200), the improved sea-surface wind speed data generation module 200 applies the sea surface temperature information and salinity concentration information in the plurality of grid information generated by the grid data generation module 100 as initial values of the SFMR 10 to calculate improved sea-surface wind speed.

In step (S200), the improved sea-surface wind speed data generation module (200), when applying the sea surface temperature information and salinity concentration information in the multiple grid information as initial values of the SFMR 10, calculates the improved sea-surface wind speed by applying the sea-surface temperature value and salinity concentration value in the grid information that is closest in time and space to the sea-surface wind speed observation mission.

Step (S300) includes a moving average calculation step (S310) for calculating a moving average, for example, a 1-minute moving average, of the calculated sea-surface wind speed in step (S200) to correct the calculated sea-surface wind speed information and remove noise, and a calculation accuracy evaluation step (S320) for evaluating the calculation accuracy of the calculated sea-surface wind speed by comparing the calculated sea-surface wind speed with heterogeneous data.

Step (S320) includes a comparison step with buoy sea-surface wind speed data (S321) for evaluating the accuracy of the improved sea-surface wind speed calculation by comparing the sea-surface wind speed calculated by the improved sea-surface wind speed data generation module 200 with the sea-surface wind speed information observed by the marine buoy, and a comparison step with dropsonde sea-surface wind speed data (S323) for evaluating the accuracy of the improved sea-surface wind speed calculation by comparing the sea-surface wind speed calculated by the improved sea-surface wind speed data generation module 200 with the sea-surface wind speed information observed by the dropsonde.

In step (S323), the sea-surface wind speed data verification module 300 can evaluate the accuracy of the improved sea-surface wind speed calculation by comparing the sea-surface wind speed value observed when the dropsonde reaches the sea surface with the sea-surface wind speed value calculated by the improved sea-surface wind speed data generation module 200.

Detailed explanations of each step are as described above.

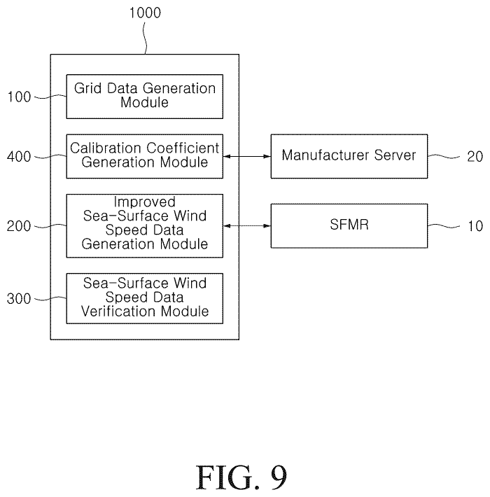

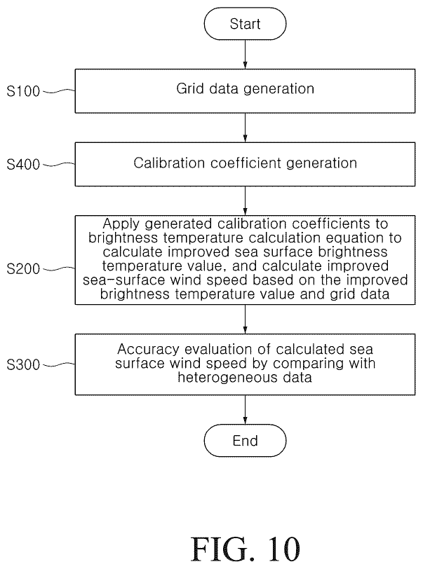

FIG. 9 is a block diagram showing each component of the sea-surface wind speed calculation and accuracy evaluation system 1000 through an improved initial input value of the sea-surface wind speed radiometer according to an embodiment of the present invention, and FIG. 10 is a flowchart showing each step of the method for calculating sea-surface wind speed and evaluating accuracy through an improved initial input value of the sea-surface wind speed radiometer according to an embodiment of the present invention.

As described above, the SFMR device (10) calculates the sea-surface wind speed based on the sea surface brightness temperature value information measured at sea, the aircraft position and attitude information (Altitude, Pitch, Roll), sea surface temperature (SST) information and salinity concentration information.

To accurately measure sea-surface wind speed and rainfall intensity using SFMR 10, periodic acquisition of accurate calibration coefficients through flight calibration under specified weather conditions is necessary.

Referring to FIG. 9, The sea-surface wind speed calculation and accuracy evaluation system 1000 through an improved initial input value of the sea-surface wind speed radiometer according to an embodiment of the present invention may further include a calibration coefficient generation module 400 that generates new calibration coefficients based on the observation data observed during the flight calibration of the meteorological aircraft. And referring to FIG. 10, the method for calculating sea-surface wind speed and evaluating accuracy through an improved initial input value of the sea-surface wind speed radiometer according to an embodiment of the present invention may further include a calibration coefficient generation step (S400) by the calibration coefficient generation module 400.

The calibration coefficient generation module 400 according to the present invention generates new calibration coefficients for accurately calculating sea surface brightness temperature values based on observation data generated during flight calibration of a meteorological aircraft. The generated new calibration coefficients are applied to the sea surface brightness temperature calculation formula to calculate more accurate sea surface brightness temperature values. SFMR 10 can calculate more accurate sea-surface wind speed based on more accurate sea surface brightness temperature values.

The calibration coefficient generation module 400 generates calibration coefficients based on observation data collected during flight calibration of the meteorological aircraft. SFMR 10 and dropsondes (not shown) are installed on the meteorological aircraft for flight calibration. The meteorological aircraft can collect observation data such as aircraft position and attitude information (Altitude, Pitch, Roll) during flight calibration.

The flight calibration of the meteorological aircraft is performed under weather conditions with sea wind speeds of 8 to 10 m/s or less, no precipitation, and cloudless sky, and is performed through flights of 1 to 5 minutes each at 1,000 feet, 5,000 feet, 10,000 feet and 20,000 feet above a buoy during nighttime flight (when there is no possibility of sun glint) under the above weather conditions.

The calibration coefficient generation module 400 can generate new calibration coefficients based on observation data acquired during flight calibration performed under the above weather conditions.

The calibration coefficients generated by the calibration coefficient generation module 400 can be generated based on observation data collected during SFMR calibration flights performed on dates suitable for the above weather conditions and operation.

As one embodiment, the calibration coefficient generation module 400 can utilize observation data collected during the SFMR calibration flight performed on Oct. 26, 2022 for generating calibration coefficients. The SFMR calibration flight performed on Oct. 26, 2022 took off from Gimpo Airport at 13:54 and started SFMR 10 observation in the East Sea from 14:30. During the calibration flight, the meteorological aircraft performed SFMR calibration flight descending to 10,000 ft from 15:16 in the CATA1 area, and 2 dropsondes were also observed together for comparative observation of sea-surface wind speed. During the calibration flight, the meteorological aircraft performed calibration flight descending to 10,000, 5,000 and 1,000 ft until 15:38, and ended SFMR 10 observation when entering land at 16:10.

The calibration coefficient generation module 400 may include a communication module (not shown) that transmits observation data collected during flight calibration to the manufacturer server 20 of SFMR 10 and receives calibration coefficients based on that observation data from the manufacturer server 20. The calibration coefficient generation module 400 can complete generation of calibration coefficients by transmitting observation data to the manufacturer server 20 through the communication module and receiving new calibration coefficients generated based on that observation data from the manufacturer server 20. That is, generation of calibration coefficients by the calibration coefficient generation module 400 can be done through the process of transmitting observation data to the manufacturer server 20 and the process of receiving calibration coefficients from the manufacturer server 20.

The calibration coefficients generated by the calibration coefficient generation module 400 are applied to the sea surface brightness temperature calculation formula (see «Equation 1> below).

The improved sea-surface wind speed data generation module 200 calculates improved sea surface brightness temperature values by applying the calibration coefficients generated by the calibration coefficient generation module 400 to the sea surface brightness temperature calculation formula. The improved sea surface brightness temperature values calculated by the improved sea-surface wind speed data generation module 200 are applied to the initial input values for improved sea-surface wind speed calculation of SFMR 10. The improved sea-surface wind speed data generation module 200 calculates sea-surface wind speed for a certain area by applying the improved sea surface brightness temperature values along with previously measured sea surface temperature information and previously measured salinity concentration information to the initial input data of SFMR 10. The improved sea-surface wind speed data generation module 200 performs SFMR 10 observation by applying new calibration coefficients to <Equation 1> in observations after the calibration flight.

$$Sea surface brightness temperature calculation formula$$

$${T}_{B} = {a}_{0} + {a}_{1} \frac{{t}_{4}}{35} + {a}_{2} γ + {a}_{3} γ \frac{{t}_{4}}{35} + {a}_{4} \frac{{t}_{5}}{35} + {a}_{5} \frac{{t}_{2}}{35} + {a}_{6} γ \frac{{t}_{3}}{35} + {a}_{7} \frac{{t}_{3}}{35} + {a}_{8} \frac{{t}_{6}}{35} \qquad Equation 1$$

Referring to Table 4, the calibration coefficients include 9 calibration coefficients aᵢ for each of the 6 channels of SFMR 10. The improved sea-surface wind speed data generation module 200 calculates the sea surface brightness temperature value T_{B}(K) by substituting 9 new calibration coefficients aᵢ and physical temperatures tᵢ(° C.) acquired for each part of SFMR 10 into Equation 1. Here, γ is calculated through digital counts recorded in the antenna, Warm calibration load, and Cold calibration load.

TABLE 4

| Freq ID [GHz] | a0 | a1 | a2 | a3 | a4 | a5 | a6 | a7 | a8 |
|---|---|---|---|---|---|---|---|---|---|
| F0 [4.74] | 275.51 | 45.14 | −350.54 | −33.11 | −4.92 | −4.64 | 0.00 | 0.00 | −2.38 |
| F1 [5.31] | 275.28 | 45.59 | −339.64 | −33.45 | −4.54 | −4.61 | 0.00 | 0.00 | −2.30 |
| F2 [5.57] | 273.97 | 45.94 | −288.81 | −24.36 | −4.01 | −5.33 | 0.00 | 0.00 | −2.92 |
| F3 [6.02] | 275.39 | 45.33 | −245.42 | −16.47 | −5.20 | −4.74 | 0.00 | 0.00 | −2.50 |
| F4 [6.69] | 275.65 | 44.28 | −157.04 | −11.40 | −4.38 | −3.91 | 0.00 | 0.00 | −2.59 |
| F5 [7.09] | 277.78 | 46.60 | −143.77 | −8.32 | −5.52 | −5.05 | 0.00 | 0.00 | −3.24 |

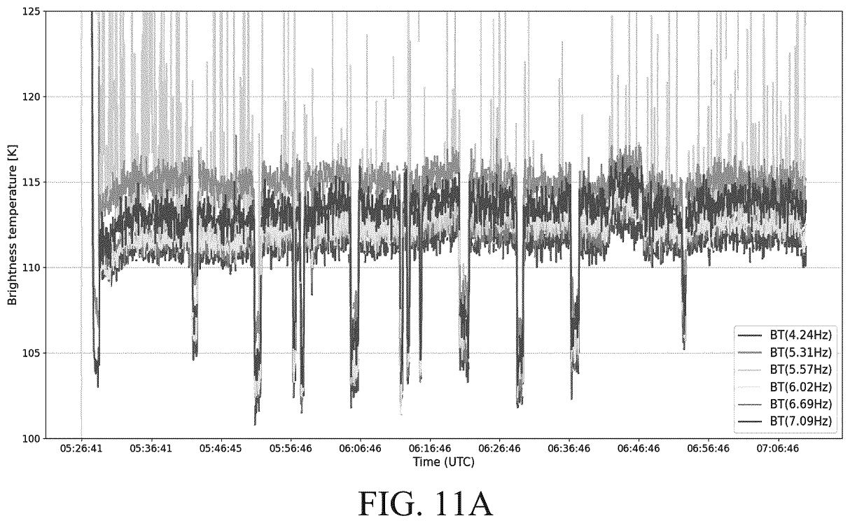

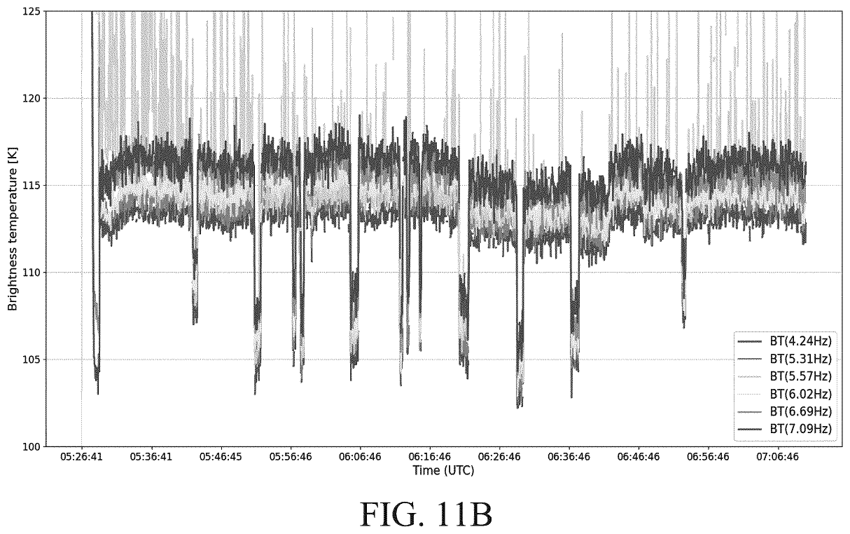

FIG. 11A is a diagram showing SFMR sea surface brightness temperature before applying new calibration coefficients, and FIG. 11B is a diagram showing SFMR sea surface brightness temperature when new calibration coefficients are applied based on observation data collected from the calibration flight on Oct. 26, 2022.

Referring to FIG. 11A and FIG. 11B, as a result of applying the new calibration coefficients, it can be seen that the SFMR sea surface brightness temperature values were generally calibrated upward compared to before calibration.

The sea-surface wind speed data verification module 300 according to the present invention evaluates the accuracy of the sea-surface wind speed calculated by the improved sea-surface wind speed data generation module 200 by comparing it with heterogeneous data. As the evaluation of sea-surface wind speed accuracy by the sea-surface wind speed data verification module 300 is as described above, detailed explanation is omitted.

In this specification, each component of the system 1000, namely the grid data generation module 100, calibration coefficient generation module 400, improved sea-surface wind speed data generation module 200, and sea-surface wind speed data verification module 300, can be processors executing consecutive execution processes stored in memory. Or, they can operate as software modules driven and controlled by a processor. Furthermore, the processor can be a hardware device.

The calibration coefficient generation module 400 and manufacturer server 20 according to the present invention can communicate through communication units and communication networks that each is equipped with. The communication network refers to a connection structure that allows information exchange between each node such as terminals and servers, and examples of such communication networks include, but are not limited to, 3GPP (3rd Generation Partnership Project) network, LTE (Long Term Evolution) network, 5G network, WIMAX (World Interoperability for Microwave Access) network, Internet, LAN (Local Area Network), Wireless LAN (Wireless Local Area Network), WAN (Wide Area Network), PAN (Personal Area Network), wifi network, Bluetooth network, satellite broadcasting network, analog broadcasting network, DMB (Digital Multimedia Broadcasting) network, etc. The calibration coefficient generation module 100 and manufacturer server 20 are each equipped with communication modules, and each communication module can include electronic components provided for the communication network to perform wired and wireless data communication through the aforementioned communication network.

For reference, the method for calculating and evaluating accuracy of sea-surface wind speed using improved calibration coefficients of a sea-surface wind speed radiometer according to the present invention can be implemented in the form of program instructions that can be executed through various computer means and recorded on a computer-readable medium. The computer-readable medium can include program instructions, data files, data structures, etc., alone or in combination. The program instructions recorded on the medium may be those specially designed and constructed for the purposes of the present invention, or they may be of the kind well-known and available to those having skill in the computer software arts. Examples of computer-readable media include magnetic media such as hard disks, floppy disks and magnetic tape, optical media such as CD-ROM discs and DVD, magneto-optical media such as floptical disks, and hardware devices that are specially configured to store and perform program instructions, such as read-only memory (ROM), random access memory (RAM), flash memory, etc. Examples of program instructions include both machine code, such as produced by a compiler, and files containing higher level code that may be executed by the computer using an interpreter. The described hardware devices may be configured to act as one or more software modules in order to perform the operations of the present invention, and vice versa.

In this specification, ‘module’ includes units realized by hardware, units realized by software, and units realized by both. Also, one unit may be realized by using two or more hardware, or two or more units may be realized by one hardware.

The scope of protection of the present invention is not limited to the description and expression explicitly explained in the above embodiments. Also, it is added once again that the scope of protection of the present invention cannot be limited due to obvious changes or substitutions in the technical field to which the present invention belongs.

What is claimed is:

1. A system for calculating and evaluating accuracy of sea-surface wind speed using improved initial input values of a sea-surface wind speed radiometer that calculates sea-surface wind speed based on sea surface brightness temperature value information measured at sea, aircraft position and attitude information, sea surface temperature (SST) information and salinity concentration information, wherein the system comprises:
a grid data generation module that generates multiple grid information containing information about sea surface temperature and salinity concentration within a certain area based on previously measured sea surface temperature information and previously measured salinity concentration information;
an improved sea-surface wind speed data generation module that calculates improved sea-surface wind speed by applying the sea surface temperature information and salinity concentration information in the generated multiple grid information to the sea-surface wind speed radiometer; and
a sea-surface wind speed data verification module that evaluates accuracy of the calculated sea-surface wind speed by comparing the calculated sea-surface wind speed with heterogeneous data.

2. The system of claim 1, wherein the grid data generation module generates the multiple grid information based on the previously measured sea surface temperature information and previously measured salinity concentration information from marine observation data of the Meteorological Administration, buoys of the Hydrographic and Oceanographic Agency, marine science stations and tide observation stations.

3. The system of claim 2, wherein the grid data generation module generates the multiple grid information having a spatial resolution of 0.1°×0.1° within the certain area.

4. The system of claim 2, wherein the grid data generation module generates multiple grid information having a time resolution corresponding to the generation interval of buoy data within the certain area.

5. The system of claim 4, wherein the multiple grid information has a time resolution of 30-minute intervals within the certain area.

6. The system of claim 1, wherein the grid data generation module verifies accuracy of the multiple grid information after generating the multiple grid information, and when verifying accuracy of the multiple grid information, compares sea surface temperature information included in each grid of the multiple grid information with sea surface temperature information in the 5th generation reanalysis data (ERA5) provided by the European Centre for Medium-Range Weather Forecasts (ECMWF).

7. The system of claim 1, wherein the sea-surface wind speed data verification module calculates a moving average of the calculated sea-surface wind speed within a predetermined time to correct the calculated sea-surface wind speed information and remove noise.

8. The system of claim 1, wherein the sea-surface wind speed data verification module evaluates accuracy of the improved sea-surface wind speed calculation by comparing the calculated sea-surface wind speed with sea-surface wind speed information observed by marine buoys.

9. The system of claim 1, wherein the sea-surface wind speed data verification module evaluates accuracy of the improved sea-surface wind speed calculation by comparing the calculated sea-surface wind speed with sea-surface wind speed information observed by dropsondes.

10. The system of claim 9, wherein the sea-surface wind speed information observed by the dropsonde applies the sea-surface wind speed value measured when the dropsonde reached the sea surface.

11. A method for calculating and evaluating accuracy of sea-surface wind speed using improved initial input values of a sea-surface wind speed radiometer that calculates sea-surface wind speed based on sea surface brightness temperature value information measured at sea, aircraft position and attitude information, sea surface temperature (SST) information and salinity concentration information, wherein the method comprises:
a grid data generation step in which a grid data generation module generates multiple grid information containing information about sea surface temperature and salinity concentration within a certain area based on previously measured sea surface temperature information and previously measured salinity concentration information;
an improved sea-surface wind speed data generation step in which an improved sea-surface wind speed data generation module calculates improved sea-surface wind speed by applying the sea surface temperature information and salinity concentration information in the generated multiple grid information to the sea-surface wind speed radiometer; and
a sea-surface wind speed data verification step in which a sea-surface wind speed data verification module evaluates accuracy of the calculated sea-surface wind speed by comparing the calculated sea-surface wind speed with heterogeneous data.

12. The method of claim 11, wherein in the grid data generation step, the previously measured sea surface temperature information and previously measured salinity concentration information are from marine observation data of the Meteorological Administration, buoys of the Hydrographic and Oceanographic Agency, marine science stations and tide observation stations.

13. The method of claim 12, wherein the multiple grid information generated in the grid data generation step has a spatial resolution of 0.1°×0.1° within the certain area.

14. The method of claim 12, wherein the multiple grid information generated in the grid data generation step has a time resolution corresponding to the generation interval of buoy data within the certain area.

15. The method of claim 14, wherein the multiple grid information generated in the grid data generation step has a time resolution of 30-minute intervals.

16. The method of claim 11, wherein the grid data generation step includes a grid data verification step of verifying accuracy of the multiple grid information after generating the multiple grid information, and the grid data verification step compares sea surface temperature information included in each grid of the multiple grid information with sea surface temperature information in the 5th generation reanalysis data (ERA5) provided by the European Centre for Medium-Range Weather Forecasts (ECMWF).

17. The method of claim 11, wherein the sea-surface wind speed data verification step includes a moving average calculation step of calculating a moving average of the calculated sea-surface wind speed within a predetermined time to correct the calculated sea-surface wind speed information and remove noise.

18. The method of claim 11, wherein the sea-surface wind speed data verification step includes a buoy sea-surface wind speed data comparison step of evaluating accuracy of the improved sea-surface wind speed calculation by comparing the calculated sea-surface wind speed with sea-surface wind speed information observed by marine buoys.

19. The method of claim 11, wherein the sea-surface wind speed data verification step includes a dropsonde sea-surface wind speed data comparison step of evaluating accuracy of the improved sea-surface wind speed calculation by comparing the calculated sea-surface wind speed with sea-surface wind speed information observed by dropsondes.

20. The method of claim 19, wherein the sea-surface wind speed information observed by the dropsonde applies the sea-surface wind speed value observed when the dropsonde reached the sea surface.
